(19) United States
(12) Patent Application Publication
(10) Pub. No.: US 2018/0052227 A1
(43) Pub. Date: Feb. 22, 2018

(54) BEAM PATTERN DIVERSITY-BASED TARGET LOCATION ESTIMATION

(71) Applicant: GM Global Technology Operations LLC, Detroit, MI (US)

(72) Inventors: Oded Bialer, Petah Tikva (IL); Igal Bilik, Rehovot (IL)

(21) Appl. No.: 15/238,044

(22) Filed: Aug. 16, 2016

(51) Int. Cl. G01S 13/42; G01S 13/93; G01S 7/35

(52) U.S. Cl. CPC G01S 13/42; G01S 7/352; G01S 13/931

(57) ABSTRACT

A method and system estimate the location of a target using a radar system. A beam pattern is obtained for each of one or more transmit antenna elements and a plurality of receive antenna elements. The method includes transmitting from at least one of the one or more transmit antenna elements, and estimating the location based on comparing a gain indicated by the beam pattern associated with each of the plurality of receive antenna elements and comparing gains of reflections resulting from the transmitting.

### FIELD OF THE INVENTION

The subject invention relates to beam pattern diversity-based target location estimation.

### BACKGROUND

In many radar applications, one or more transmit antenna elements is used to transmit radiation, and the resulting reflections, which are received by one or more receive antenna elements, indicate information about one or more targets. One such system is a multi-input multi-output (MIMO) radar system. Each receive antenna element receives reflections resulting from every transmit antenna element, and the number of transmit and receive antenna elements need not be equal. Each antenna element likely does not exhibit the same gain in all directions. For example, each receive antenna element in the array does not receive radiation with the same gain at every angle in the azimuthal plane. The beam pattern of a given antenna element indicates the directional (angular) dependence of the gain. When the beam patterns in a given dimension (e.g., azimuthal dimension when the array is a horizontal linear array of antenna elements) are identical among receive antenna elements, then any phase difference among reflections received by the receive antenna elements relates to the angle of arrival, and the position of the target is easily resolved. However, manufacturing antenna elements to have identical beam patterns can present a challenge. Further, information in another dimension (e.g., elevation when the array is a horizontal linear array of antenna elements) is not provided by an array that exhibits identical beam patterns. Accordingly, it is desirable to perform beam pattern diversity-based target location estimation.

### SUMMARY OF THE INVENTION

In one exemplary embodiment of the invention, a method of estimating location of a target using a radar system includes obtaining a beam pattern for each of one or more transmit antenna elements and a plurality of receive antenna elements; transmitting from at least one of the one or more transmit antenna elements; and estimating the location based on comparing a gain indicated by the beam pattern associated with each of the plurality of receive antenna elements and comparing gains of reflections resulting from the transmitting.

In another exemplary embodiment, a system to estimate a location of a target includes a radar system including one or more transmit antenna elements and a plurality of receive antenna elements; a memory device configured to store a beam pattern exhibited by each of the one or more transmit antenna elements and the plurality of receive antenna elements; and a processor configured to estimate the location based on comparing a gain indicated by the beam pattern associated with each of the plurality of receive antenna elements and comparing gains of reflections resulting from the transmitting.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 illustrates beam pattern diversity of receive antenna elements in the azimuthal dimension according to an embodiment;

FIG. 2 illustrates beam pattern diversity of transmit antenna elements in the azimuthal dimension according to an embodiment;

FIG. 3 shows beam patterns associated with transmit antenna elements according to an embodiment; and

FIG. 4 shows beam patterns associated with receive antenna elements according to an embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

As previously noted, for a given transmission, when the receive antenna elements are arranged in a linear array (e.g., in the azimuthal plane) and have identical beam patterns, then angle of arrival of a target reflection (e.g., determination of target position in the azimuthal plane) can be determined based on the phase difference among the reflections received by the different antenna elements. The beam pattern refers to the directional (angular) dependence of transmitted or received signal strength. For example, one transmit element may have a peak gain of 6.8 decibels-isotropic (dBi) at an azimuth angle of +15 degrees, while another transmit element may have a peak gain of 7.3 dBi at an azimuth angle of +5 degrees and a gain of only 4.5 dBi at +15 degrees. Rather than assuming identical beam patterns or trying to achieve identical beam patterns among all the antenna elements, embodiments of the systems and methods detailed herein take advantage of differences in the beam patterns of each antenna element.

This beam pattern diversity-based direction of arrival estimation, according to one embodiment, involves using beam pattern diversity rather than phase differences to determine direction of arrival in a single dimension. According to another embodiment, minimal beam pattern diversity is assumed in the dimension in which antenna elements are arranged (e.g., in azimuth), and beam pattern diversity in another dimension (e.g., elevation) is used to determine target position in that dimension. According to yet another embodiment, beam pattern diversity alone is used to determine the position of the target, and phase difference is not used in any dimension. The beam patterns of both transmit and receive elements are known and used according to embodiments discussed herein. That is, the beam pattern diversity among receive antenna elements is relevant to discerning direction of arrival for reflections associated with a given transmit element. When there is more than one transmit element (e.g., in a MIMO system), the beam pattern diversity among transmit antenna elements is relevant to comparing the direction of arrival that is determined based on the two or more different transmissions.

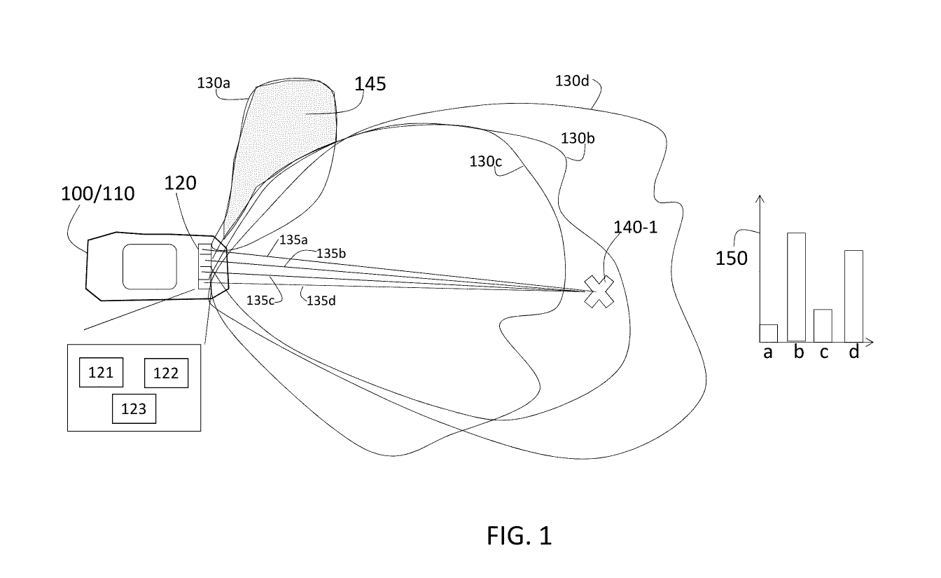

FIG. 1 illustrates beam pattern diversity of receive antenna elements 122 in the azimuthal dimension according to an embodiment. A platform 100 including a radar system 120 is shown. The platform 100 is an automobile 110 in the exemplary embodiment shown in FIG. 1. In alternate embodiments, the platform 100 may be a different vehicle or even a stationary support. The radar system 120 is well-known and is not detailed herein. The radar system 120 includes one or more transmit antenna elements 121 and a plurality of receive antenna elements 122. Four receive antenna elements 122 are in the exemplary radar system 120 of FIG. 1. The radar system 120 may also include other known components such as a controller 123. The controller 123 may be specific to the radar system 120 or may additionally perform other functions in the automobile 110 such as collision avoidance or steering control. The controller 123 generally includes processing circuitry that may include an application specific integrated circuit (ASIC), an electronic circuit, a processor (shared, dedicated, or group) and memory that executes one or more software or firmware programs, a combinational logic circuit, and/or other suitable components that provide functionality such as generation of transmitted signals and processing of received signals. When more than one transmit antenna element 121 is part of the radar system 120, the transmission of each transmit antenna element 121 is distinguished based on a time division multiple access (TDMA) scheme or based on each transmit antenna element 121 transmitting a different code, for example. The transmission may be a linear frequency modulated continuous wave (LFM-CW), for example.

Four different beam patterns 130a through 130d (generally, 130) are shown corresponding with the four exemplary receive antenna elements 122. While the beam patterns 130 show the regions with relatively stronger gain, other regions are not intended to be conveyed as regions with no return. For example, given the beam pattern 130a, the associated receive antenna elements 122 still receives a reflection (albeit one with very low gain) from the target 140-1, which is outside the illustrated beam pattern 130a. The exemplary receive antenna elements 122 are arranged in a linear array along the azimuthal plane, and a cross section of the beam patterns 130 (which are three-dimensional) in the azimuthal plane is shown. This exemplary arrangement is shown only for explanatory purposes. The receive antenna elements 122 may instead be arranged in a linear array in another plane (e.g., the elevation plane), and the beam patterns 130 may instead be in that other plane (e.g., elevation plane).

As noted, an exemplary target 140-1 is shown, and FIG. 1 indicates the reflection 135a through 135d associated with each receive antenna element 122 which corresponds with each of the illustrated beam patterns 130a through 130d. FIG. 1 also indicates the relative radiation gain 150 associated with each receive antenna element 122 at the location of the target 140-1 based on the corresponding beam pattern 130. For example, the reflection 135a associated with the receive antenna element 122 corresponding with beam pattern 130a exhibits the lowest gain at the location of the target 140-1, as compared with all the reflections 135a through 135d. As another example, the reflection 135b associated with the receive antenna element 122 corresponding with beam pattern 130b exhibits the highest gain at the location of the target 140-1.

Knowledge of the beam patterns 130 facilitates resolution of angular estimates based on each of the receive antenna elements 122. For example, when the reflection 135a received at the receive antenna element 122 that is associated with beam pattern 130a exhibits the highest gain among the reflections 135a through 135d, then the corresponding target must be in region 145, for which the beam pattern 130a exhibits the highest gain (relative to the other beam patterns 130).

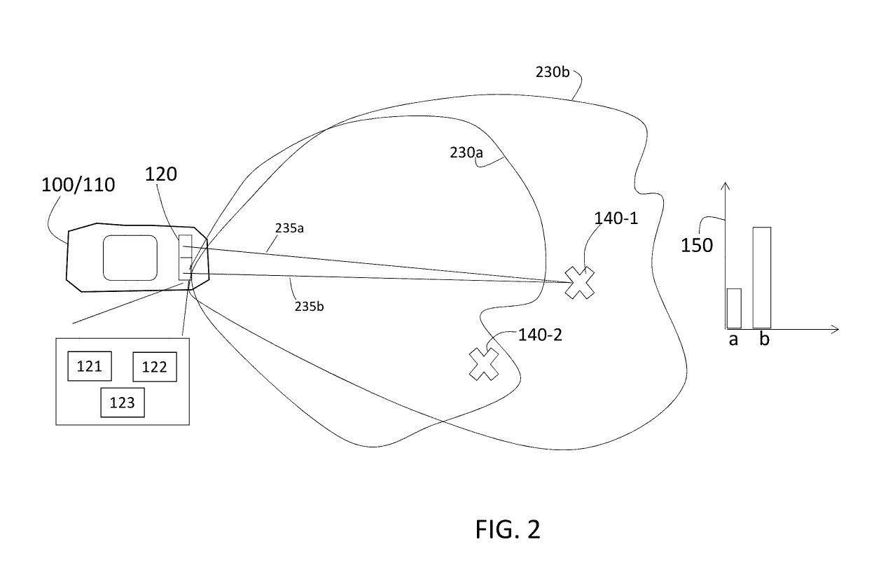

FIG. 2 illustrates beam pattern diversity of transmit antenna elements 121 in the azimuthal dimension according to an embodiment. As noted with reference to FIG. 1, the transmit antenna elements 121 are assumed to be in a linear array in the azimuthal plane for explanatory purposes, and an azimuthal cross-section of the beam patterns 230a and 230b (generally, 230) is shown. However, the arrangement of the transmit antenna elements 121 and the plane in which the beam patterns 230 are shown could be different. FIG. 2 shows two exemplary beam patterns 230a and 230b associated with two exemplary transmit antenna elements 121. The exemplary target 140-1 from FIG. 1 is shown in FIG. 2, as well. The relative gains 150 of the transmissions 235a and 235b associated with the transmit antenna elements 121 corresponding with the beam patterns 230a and 230b are shown at the location of the target 140-1. These indicate that the relative gain 150 associated with beam pattern 230b is higher than the relative gain 150 associated with beam pattern 230a at the location of target 140-1.

This means that the reflections 135 received by the receive antenna elements 122 will have a lower gain when those reflections 135 result from transmission by the transmit antenna element 121 associated with beam pattern 230a (rather than with beam pattern 230b). Based on the location of the target 140-1, the relative gain 150 distribution among the reflections 135a through 135d (shown in FIG. 1) will remain unchanged, but the gain values will be lower when the reflections 135a through 135d result from transmissions by the transmit antenna element 121 associated with beam pattern 230a. Thus, when the radar system 120 includes more than one transmit antenna element 121, knowing the beam pattern 230 of each of the transmit antenna elements 121 provides another layer of information in resolving the location of any detected target 140.

A second target 140-2 is shown in FIG. 2. Again, the relative gain 150 distribution among the receive antenna elements 122 will not change with respect to the target 140-2 regardless of which transmit antenna element 121 caused the received reflections 135. However, the gain values will be higher for reflections 135 received as a result of transmission by the transmit antenna element 121 associated with beam pattern 230a.

According to another embodiment, the beam patterns 130, 230 can be assumed to have minimal diversity in the same plane in which the antenna elements (121, 122) are arranged (e.g., in the azimuthal plane). In this case, phase differences in reflections 135 received among the receive antenna elements 122 may still be used to determine angle of arrival of the reflections 135 in that plane (e.g., azimuthal plane). Then, according to this embodiment, the diversity of the beam patterns 130, 230 in another plane (e.g., elevation) could be used to determine the angle of arrival of reflections 135 in that plane. Thus, even though an array of antenna elements (121, 122) is arranged only in the azimuthal plane, for example, determination of the location of the target 140 in another plane, such as in elevation, is facilitated. The process for determining the location of the target 140 in the other plane (e.g., in elevation) would be similar to the process discussed with reference to FIGS. 1 and 2.

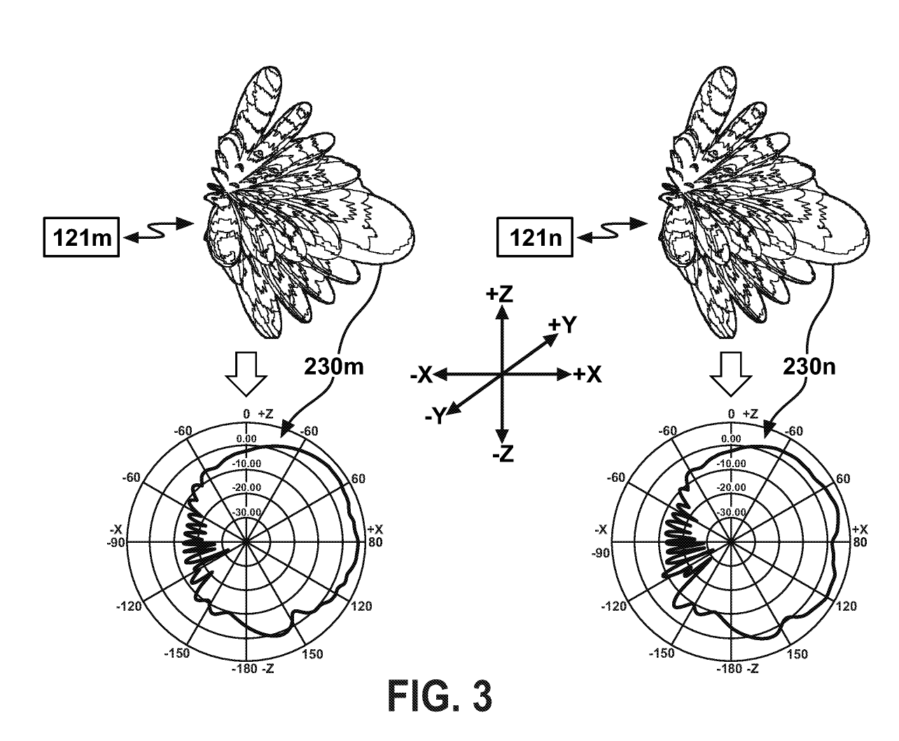

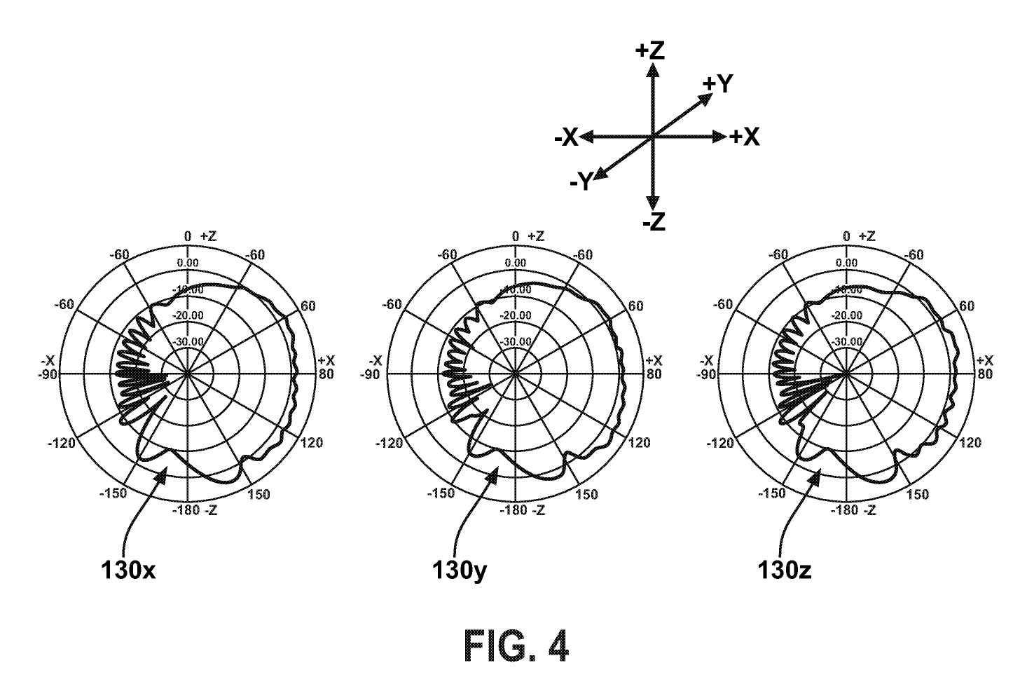

FIG. 3 shows beam patterns 230m, 230n associated with transmit antenna elements 121m, 121n according to an embodiment. A cross-section of each beam pattern 230m, 230n is shown in the elevation plane (X/Z plane, as indicated). FIG. 4 shows beam patterns 130x, 130y, 130z associated with receive antenna elements 122 according to an embodiment. The beam patterns 130x, 130y, 130z are cross-sections shown in the elevation plane (X/Z plane). At any given elevation angle, the beam patterns 130, 230 are designed to maintain a constant differential with the other beam patterns 130, 230 over azimuth. That is, for example, at an elevation angle of five degrees, the difference in gain between beam patterns 230m and 230n is 5 dBi. This difference is maintained at each azimuth angle at that elevation angle.

According to the current embodiment, the angle of arrival in the azimuthal plane is determined based on a phase difference among the reflections 135 received by the different receive antenna elements 122. With respect to the angle of arrival in the elevation plane, however, the different gains exhibited by the beam patterns 230m, 230n and 130x, 130y, 130z of each of the transmit antenna elements 121 and receive antenna elements 122, respectively, are used. The procedure is similar to the way that direction of arrival of reflections in the azimuth plane is determined according to the discussion of FIGS. 1 and 2. Specifically, the relative gain 150 is used in conjunction with the known beam patterns 130, 230.

According to yet another embodiment, known beam patterns 130, 230 may be used to determine the location of a target 140 in every dimension. That is, minimal diversity need not be assumed in the azimuthal plane or another plane such that phase differences are not used to determine direction of arrival at all. In every embodiment, knowing the beam pattern 130, 230 of each antenna element (121, 122) has the technical effect of facilitating determination of direction of arrival of reflections (location of a target 140) without using phase difference among received reflections.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method of estimating location of a target using a radar system, the method comprising:
obtaining a beam pattern for each of one or more transmit antenna elements and a plurality of receive antenna elements;
transmitting from at least one of the one or more transmit antenna elements; and
estimating the location based on comparing a gain indicated by the beam pattern associated with each of the plurality of receive antenna elements and comparing gains of reflections resulting from the transmitting.

2. The method according to claim 1, wherein the estimating the location includes narrowing the location to one or more areas in which relative gains among the beam patterns associated with each of the plurality of receive antenna elements match relative gains of the reflections received by each of the plurality of receive antenna elements.

3. The method according to claim 2, wherein the estimating the location includes further narrowing the location based on relative gains among the beam patterns associated with each of two or more transmit antenna elements in the one or more areas.

4. The method according to claim 1, wherein the estimating the location is in one plane.

5. The method according to claim 4, further comprising determining a location in another plane based on a phase difference among the reflections associated with one of the plurality of transmit elements.

6. A system to estimate a location of a target, the system comprising:
a radar system including one or more transmit antenna elements and a plurality of receive antenna elements;
a memory device configured to store a beam pattern exhibited by each of the one or more transmit antenna elements and the plurality of receive antenna elements; and
a processor configured to estimate the location based on comparing a gain indicated by the beam pattern associated with each of the plurality of receive antenna elements and comparing gains of reflections resulting from the transmitting.

7. The system according to claim 6, wherein the processor narrows the location to one or more areas in which relative gains among the beam patterns associated with each of the plurality of receive antenna elements match relative gains of the reflections received by each of the plurality of receive antenna elements.

8. The system according to claim 7, wherein the processor further narrows the location based on relative gains among the beam patterns associated with each of two or more transmit antenna elements in the one or more areas.

9. The system according to claim 6, wherein the processor estimates the location in a plane that is perpendicular to another plane in which the plurality of receive antenna elements are arranged in a linear array.

10. The system according to claim 9, wherein the processor determines a location in the another plane based on a phase difference among the reflections associated with one of the plurality of transmit elements and uses the location in the another plane to estimate the location in the one plane.
